(19) United States
(12) Patent Application Publication
(10) Pub. No.: US 2012/0239688 A1
(43) Pub. Date: Sep. 20, 2012

(54) TABLE LOOKUP APPARATUS, TABLE LOOKUP METHOD, AND TABLE LOOKUP SYSTEM

(76) Inventor: Takatoshi Yanase, Hyogo (JP)

(21) Appl. No.: 13/513,282

(22) PCT Filed: Dec. 2, 2010
(86) PCT No.: PCT/JP2010/007024

§ 371 Date: Jun. 1, 2012

(30) Foreign Application Priority Data
Dec. 4, 2009 (JP) 2009 275993
Dec. 4, 2009 (JP) 2009 275994
Jul. 16, 2010 (JP) 2010161242

(51) Int. Cl. G06F 17/30

(52) U.S. Cl. 707/769; 707/E17.014

(57) ABSTRACT

A table lookup apparatus includes: receiving and processing units (220, 221) each for storing one of split tables having a first column and a second column; a transmission unit (210); and a control unit (230) which sends a search query including a column identifier specifying one of the first and second columns and a search value to the transmission unit (210), wherein the transmission unit transmits the search query received from the control unit to all the receiving and processing units, and each of the receiving and processing units outputs, as the output retrieval value, a value included in the column associated with the column specified by the column identifier, when the search value in the search query is included in the column specified by the column identifier.

### TECHNICAL FIELD

The present invention relates to a table lookup apparatus, a table lookup method, and a table lookup system for lookup of a data table stored in dispersion in a network.

### BACKGROUND ART

Conventionally, use of what is known as databases has been very popular as a technique for fast lookup of data represented in a table structure including rows and columns (the data is hereinafter referred to as a data table).

In use of such a database, data for faster lookup of a mass of data table, namely, an index is prepared. A search engine for a database first looks up the index instead of directly looking up the data table so that the storage location where a data item to be retrieved is in the database can be determined fast (for example, see PTL 1).

### CITATION LIST

### Patent Literature

### [PTL 1] Japanese Unexamined Patent Application Publication No. 2001-282813

### SUMMARY OF INVENTION

### Technical Problem

However, there are the following two major problems with generation of an index of a database.

One of the problems is that generation of an index is computationally expensive. This is because it involves complex computations and a new index needs to be generated each time new data is added to the database.

This is very problematic particularly in the case where data is frequently updated.

The other problem is that in general, an apparatus on which a database is implemented is inevitably large in order to solve the above problem.

For example, a key-value store (KVS) database system includes two types of computers: one for storing and handling only index information, and the other for storing and handling data to be looked up. First, a computer storing data to be looked up is identified using a computer of the former type, and then the data stored on the identified computer is looked up so that load of index management is distributed. However, this system necessarily includes a plurality of computers, which is a problem in terms of installation space, costs, and power conservation.

In view of this, the present invention has an object of providing a table lookup apparatus which is capable of lookup of a data table without generating an index, as fast as apparatuses which generate an index.

### Solution to Problem

A table lookup apparatus according to an aspect of the present invention includes: a plurality of receiving and processing units each configured to store a corresponding one of split tables generated by splitting a data table having a table structure of rows and columns into the rows, the columns including a first column and a second column associated with the first column; a transmission unit; and a control unit configured to send, to the transmission unit, a search query including a column identifier and a search value, receive an output retrieval value, and output the received output retrieval value, the column identifier specifying one of the first column and the second column, and the output retrieval value being an output value from each of the receiving and processing units, wherein the transmission unit is configured to send the search query received from the control unit to all the receiving and processing units, and each of the receiving and processing units is configured to determine whether or not the search value in the received search query is included in the column specified by the column identifier included in the search query, and output, as the output retrieval value, a value included in the column associated with the column specified by the column identifier, when the search value is included in the column specified by the column identifier.

In this configuration, the data table is segmented into a plurality of split tables and stored in the receiving and processing units. It is therefore possible for each of the receiving and processing units to fast determine whether or not the search value included in the search query is included in the column specified by the column identifier included in the search query, compared to the case where the whole of the data table is looked up.

A table lookup apparatus capable of lookup of a data table without generating an index as fast as apparatuses which generate an index is thus provided.

Furthermore, the table lookup apparatus may further include a split unit configured to generate the plurality of split tables from the data table, wherein the control unit is configured to receive the split tables from the split unit, and store each of the received split tables in a corresponding one of the receiving and processing units.

With this, when the table lookup apparatus receives a new data table, the table lookup apparatus can generate split tables corresponding to the new data table by splitting the new data table using the split unit. The data table to be looked up can be thus updated.

Furthermore, the split unit is configured to select, for the data table, one of the first column and the second column as a reference column, and generate the split tables so that in each of the split tables, all values included in the reference column are the same.

This ensures that all values included in the reference column of the split table stored in each of the receiving and processing units are the same. A table lookup apparatus capable of faster lookup of a data table without generating an index can be thus provided.

Furthermore, the split unit is configured to select one of the first column and the second column as a reference column for the data table, and generate the split tables so that (A) in each of the split tables, all values included in the reference column are the same and (B) the value included in the reference column of each of the split tables is unique to the split table.

This ensures that the value in the reference column of the split table stored in each of the receiving and processing units is unique to the split table, and not included in any other split tables. A table lookup apparatus capable of faster lookup of a data table can be thus provided.

Specifically, the control unit is configured to send, to the transmission unit, the search query in which (i) an identifier specifying the reference column is included as the column identifier and (ii) a value for which the reference column is looked up is included as the search value.

Optionally, the control unit may be configured to send, to the transmission unit, the search query in which (i) an identifier specifying a third column is included as the column identifier and (ii) a value for which the third column is looked up is included as the search value, the third column being the other of the first column and the second column and being associated with the reference column which is the one of the first column and the second column.

In a table lookup apparatus according to another aspect of the present invention, the split unit is configured to generate the plurality of split tables by splitting the data table into single rows.

This simplifies the process of the split unit so that costs, size, or power consumption of the table lookup apparatus can be reduced.

In a table lookup apparatus according to another aspect of the present invention, two or more of the receiving and processing units share a lookup unit which is a processing unit configured to determine whether or not the search value is included in the column specified by the column identifier.

The lookup unit is thus shared so that the number of components of the table lookup apparatus can be reduced. As a result, costs, size, or power consumption of the table lookup apparatus can be reduced.

It should be noted that the present invention can be implemented not only as such a table lookup apparatus but also as a table lookup method including the characteristic units of the table lookup apparatus as steps, or as a program which causes a computer to execute such characteristic steps. Obviously, such a program can be distributed via recording media such as a CD-ROM or transmission media such as the Internet.

Furthermore, the present invention can also be implemented as a semiconductor integrated circuit (LSI) which performs all or part of the functions of such a table lookup apparatus.

Furthermore, the present invention can also be implemented as a table lookup system including such a table lookup apparatus.

### ADVANTAGEOUS EFFECTS OF INVENTION

The present invention thus provides a table lookup apparatus which generates no index and is capable of lookup of a data table as fast as apparatuses which generate an index.

### BRIEF DESCRIPTION OF DRAWINGS

FIG. 1 is a block diagram showing an overall configuration of a table lookup system including a table lookup apparatus according to Embodiment 1 of the present invention.

FIG. 2 is a block diagram showing a hardware configuration of a computer system using which the table lookup system including the table lookup apparatus according to any of Embodiments 1 to 4 of the present invention is implemented.

FIG. 3A shows a data table recorded on the table lookup apparatus according to any of Embodiments 1 to 4 of the present invention.

FIG. 3B shows junctions between neurons indicated by the data table shown in FIG. 3A.

FIG. 4A shows a first split table stored in the table lookup apparatus according to Embodiment 1 of the present invention.

FIG. 4B shows a second split table stored in the table lookup apparatus according to Embodiment 1 of the present invention.

FIG. 5A shows a first search query in the table lookup system according to any of Embodiments 1 to 4 of the present invention.

FIG. 5B shows a second search query in the table lookup system according to any of Embodiments 1 to 4 of the present invention.

FIG. 6 shows a lookup process performed on the second search query shown in FIG. 5B by the table lookup apparatus according to any of Embodiments 1 to 4 of the present invention.

FIG. 7 is a flowchart showing steps of the process performed in the table lookup system according to any of Embodiments 1 to 4 of the present invention.

FIG. 8 is a flowchart showing steps of the lookup process performed by a receiving and processing unit according to any of Embodiments 1 to 4 of the present invention.

FIG. 9 is a block diagram showing an overall configuration of a table lookup system including a table lookup apparatus according to Embodiment 2 of the present invention.

FIG. 10A shows a first split table stored in the table lookup apparatus according to Embodiment 2 of the present invention.

FIG. 10B shows a second split table stored in the table lookup apparatus according to Embodiment 2 of the present invention.

FIG. 10C shows a third split table stored in the table lookup apparatus according to Embodiment 2 of the present invention.

FIG. 11 is a block diagram showing an overall configuration of a table lookup system including a table lookup apparatus according to Embodiment 3 of the present invention.

FIG. 12 is a block diagram showing an overall configuration of a table lookup system including a table lookup apparatus according to Embodiment 4 of the present invention.

### DESCRIPTION OF EMBODIMENTS

Embodiments of a table lookup apparatus according to the present invention shall be described below in detail with reference to the drawings.

### Embodiment 1

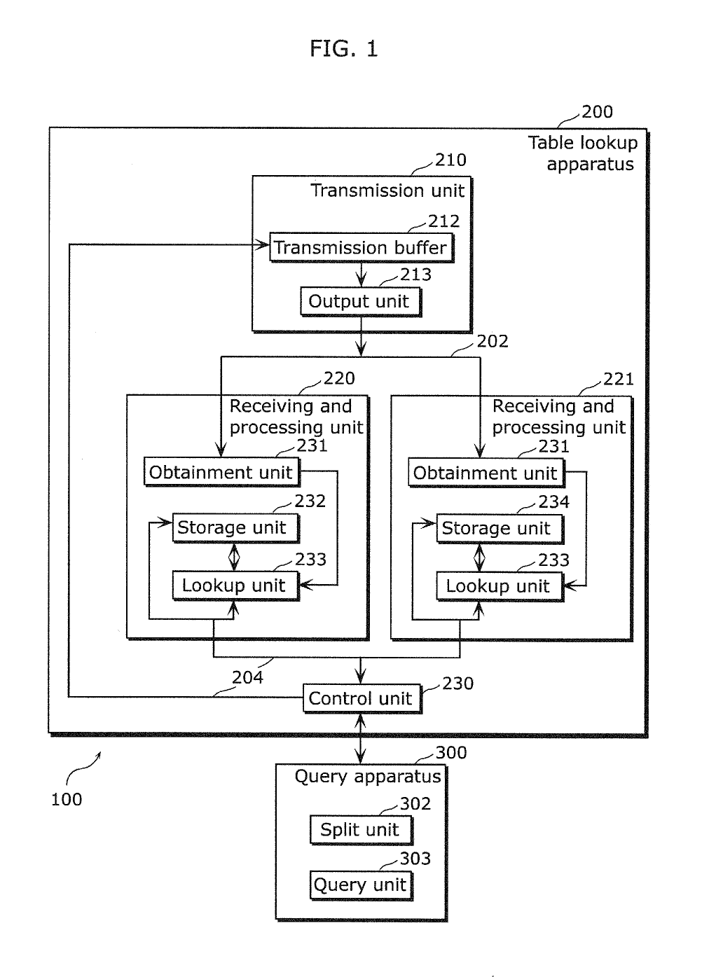

FIG. 1 is a block diagram showing an overall configuration of a table lookup system 100 including a table lookup apparatus 200 according to the present invention.

As shown in FIG. 1, the table lookup system 100 includes the table lookup apparatus 200 and a query apparatus 300.

The table lookup apparatus 200 stores a data table to be looked up, which is split in units of split tables as described later. Furthermore, the table lookup apparatus 200 retrieves, from the data table, a search value included in a search query, which is a signal sent from the query apparatus 300 to request a lookup process, and sends the retrieval result as an output retrieval value to the query apparatus 300.

In the data table, values are stored in cells each specified by a row and a column of the data table. More specifically, in the data table, a value in a first column is associated with a value in a second column, and the value in the first column and the value in the second column associated with each other are placed in the same row.

When no value is stored in a cell, the cell is considered as having a value of null. It should be noted that the table lookup apparatus 200 can perform a lookup process as long as at least one of the cells in either the first column or the second column of the data table stores a value. Although the table lookup apparatus 200 can still perform a lookup process even when none of the cells in the first column and the second column stores a value in the data table, the lookup process performed is meaningless.

The table lookup apparatus 200 includes a transmission unit 210, receiving and processing units 220 and 221, a control unit 230, a first transmission channel 202, and a second transmission channel 204.

The transmission unit 210 is a processing unit which sends a search query received from the query apparatus 300 to each of the receiving and processing units included in the table lookup apparatus 200.

The transmission unit 210 includes a transmission buffer 212 and an output unit 213.

The transmission buffer 212 is a buffer to temporarily hold search queries until they are sent to the receiving and processing units when a large number of search queries are received at once. Specifically, the transmission buffer 212 is configured using dynamic random access memory (DRAM), static random access memory (SRAM), or the like.

The output unit 213 converts the received search query into a signal of a type appropriate for the first transmission channel 202 and outputs the signal. For example, when the first transmission channel 202 is a bus inside an LSI or an Ethernet cable, the output unit 213 outputs the search query as an electric signal in an appropriate format (Ethernet is a registered trademark). When the first transmission channel 202 is an optical cable, the output unit 213 outputs the search query as an optical signal in an appropriate format.

As described above, the output unit 213 sends all search queries to all the receiving and processing units included in the table lookup apparatus 200.

The receiving and processing units 220 and 221 are receiving and processing units which perform a practical table lookup process. The table lookup apparatus 200 includes at least the number of receiving and processing units equivalent to the number of split tables described later. Here, assume for illustrative purposes that the table lookup apparatus 200 includes two receiving and processing units, that is, the receiving and processing unit 220 and the receiving and processing unit 221.

The receiving and processing unit 220 includes an obtainment unit 231, a storage unit 232, and a lookup unit 233. The receiving and processing unit 221 also includes an obtainment unit 231, a storage unit 234, and a lookup unit 233.

The obtainment unit 231 is a communication interface for receiving the search query sent from the transmission unit 210 through the first transmission channel 202.

Each of the storage unit 232 and the storage unit 234 stores a split table which is a part of a data table to be looked up and sent from the control unit. It should be noted that each receiving and processing unit stores only one split table. Specifically, the storage units are configured using, DRAM, SRAM, or non-volatile memory such as flash memory.

The lookup unit 233 performs a lookup process to determine whether or not a search value included in a search query received by the obtainment unit 231 is stored in the storage unit. When the lookup unit 233 determines that the search value included in the search query is stored in the storage unit by the lookup process, the lookup unit 233 sends a retrieval result as an output retrieval value to the control unit 230 through the second transmission channel 204.

The control unit 230 receives a plurality of split tables from the query apparatus, and sends, through the second transmission channel 204, each of the received split tables to a corresponding one of the receiving and processing units which is designated by the query apparatus for the split tables. The control unit 230 also receives a search query from the query apparatus and sends the received search query to the transmission unit 210 through the second transmission channel 204. The control unit 230 also receives, through the second transmission channel 204, the output retrieval value from the lookup units 233 included in the receiving and processing units 220 and 221, and outputs the output retrieval value to the query apparatus 300.

The first transmission channel 202 is a transmission channel to transmit a search query from the output unit 213 included in the transmission unit 210 to each of the receiving and processing units 220 and 221. As described above, an internal bus in an integrated circuit, an Ethernet cable, or an optical cable can be used as the first transmission channel 202.

The second transmission channel 204 is a transmission channel to transmit a search query from the control unit 230 to the transmission unit 210. The second transmission channel 204 is also a transmission channel to transmit a split table from the control unit 230 to each of the receiving and processing units and to transmit a retrieval result from each of the receiving and processing units to the control unit 230. As with the first transmission channel 202, an internal bus in an integrated circuit, an Ethernet cable, or an optical cable can be used as the second transmission channel 204.

The query apparatus 300 includes a split unit 302 and a query unit 303.

The split unit 302 splits the data table to be looked up into a plurality of split tables which is data represented in a table structure and are to be stored in the table lookup apparatus 200, and assigns each of the split tables to a corresponding one of the receiving and processing units included in the table lookup apparatus 200.

More specifically, the split unit 302 obtains a data table designated by a user using, for example, a graphical user interface (GUI, not shown in the drawings) included in the query apparatus 300, and then splits the data table into a plurality of split tables according to a rule as described later.

Next, the split unit 302 designates a pair of two addresses for each of the split tables as its destination. One of the two addresses is a network address which is a unique identifier of the table lookup apparatus 200. The other is a receiving and processing unit address which is a unique identifier of each of the receiving and processing units included in the table lookup apparatus 200. Subsequently, the split unit 302 causes the control unit 230 to send each of the split tables to the designated destination.

For example, the split tables are assigned to the respective receiving and processing units in the following manner, based on an assumption that the split unit 302 has a management table indicating current assignment of the split tables to the receiving and processing units. The split unit 302 searches the management table from its top (or bottom) to determine a receiving and processing unit to which no split table is currently assigned, and assigns a generated split table to the determined receiving and processing unit on a one-to-one basis.

The query unit 303 sends a search query for searching the split tables stored in the receiving and processing units to the control unit 230. For example, the search query may be generated each time based on information received from a user through the GUI included in the query apparatus 300. Optionally, the query unit 303 may read a search query stored in read-only memory (ROM) or the like.

The query apparatus 300 also receives, from the control unit 230, a retrieval result for the search query which the query apparatus 300 has sent. In the case where the query apparatus 300 is provided with a display device (not shown in the drawings), the query apparatus 300 may display the received retrieval result on the display device. In the case where the query apparatus 300 is provided with a printing device (not shown in the drawings), the query apparatus 300 may cause the printer to print the received retrieval result.

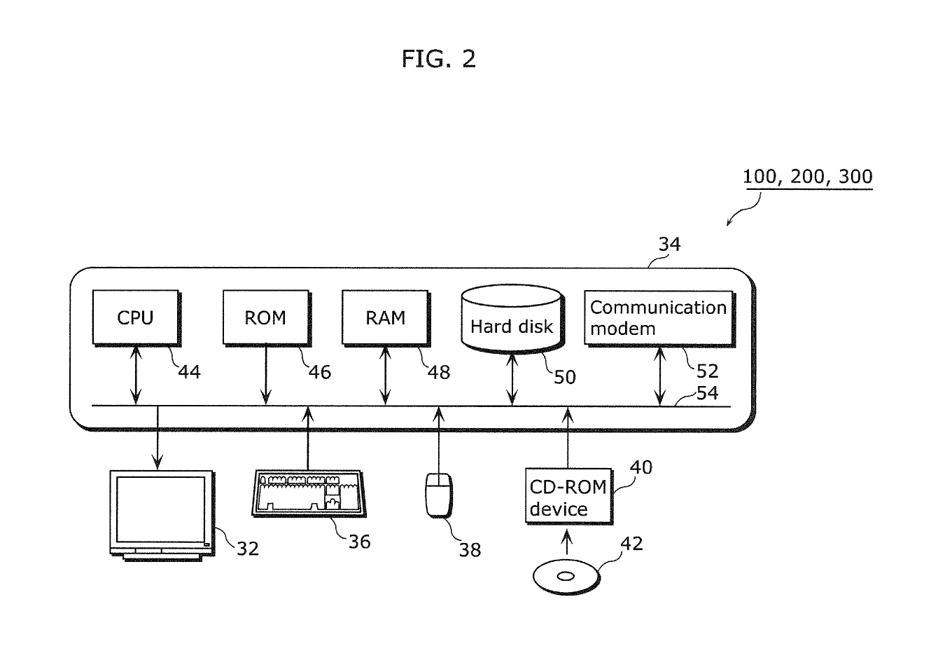

FIG. 2 is a block diagram showing a hardware configuration of a computer system using which the table lookup system 100 including the table lookup apparatus 200 according to Embodiment 1 of the present invention is implemented.

The table lookup apparatus 200 and the query apparatus 300 included in the table lookup system 100 according to Embodiment 1 can be implemented as a computer. FIG. 2 is a block diagram showing a hardware configuration of a computer system using which the table lookup apparatus 200 and the query apparatus 300 included in the table lookup system 100 are implemented.

The table lookup apparatus 200 and the query apparatus 300 included in the table lookup system 100 includes a computer 34, a keyboard 36 and a mouse 38 to issue an instruction to the computer 34, a display 32 to present information such as a result of calculation by the computer 34, a compact disc read-only memory (CD-ROM) device 40 to read a program to be executed by the computer 34, and a communication modem (not shown in the drawings).

The program indicating the process to be performed by the table lookup apparatus 200 and the query apparatus 300 included in the table lookup system 100 is stored in a CD-ROM 42, which is a computer-readable medium, and read by the CD-ROM device 40. Optionally, the program may be read through the communication modem 52 via a computer network.

The computer 34 includes a central processing unit (CPU) 44, read-only memory (ROM) 46, random access memory (RAM) 48, a hard disk 50, a communication modem 52, and a bus 54.

The CPU 44 executes the program read through the CD-ROM device 40 or the communication modem 52. The ROM 46 stores a program or data necessary for the computer 34 to operate. The RAM 48 stores data such as a parameter when a program is executed. The hard disk 50 stores a program or data. The communication modem 52 communicates with another computer through a computer network. The bus 54 interconnects the CPU 44, the ROM 46, the RAM 48, the hard disk 50, the communication modem 52, the display 32, the keyboard 36, the mouse 38, and the CD-ROM device 40.

Furthermore, all or part of the constituent elements constituting the respective devices may be configured as a single system large scale integrated circuit (LSI). The system LSI is a super-multifunctional LSI manufactured by integrating constituent units on one chip, and is specifically a computer system including a microprocessor, ROM, and RAM. The RAM stores a computer program. The microprocessor operates according to the computer program so that the system LSI can perform its function.

Furthermore, all or part of the constituent elements constituting the respective devices may be configured as an IC card or as a unit of a module which can be attached to and detached from the respective devices. The IC card or the module is a computer system configured to include a microprocessor, ROM, and RAM. The IC card or the module may include the above-mentioned super-multifunctional LSI. The microprocessor operates according to a computer program so that the IC card or the module can perform its function. The IC card and the module may be tamper-resistant.

Furthermore, the present invention may be implemented as a computer system including a microprocessor and memory. The memory stores the above-mentioned computer program so that the microprocessor can operate according to the computer program.

The program may be executed by another separate computer system to which the program is transferred by the above-mentioned medium on which the program is recorded or by the above-mentioned network.

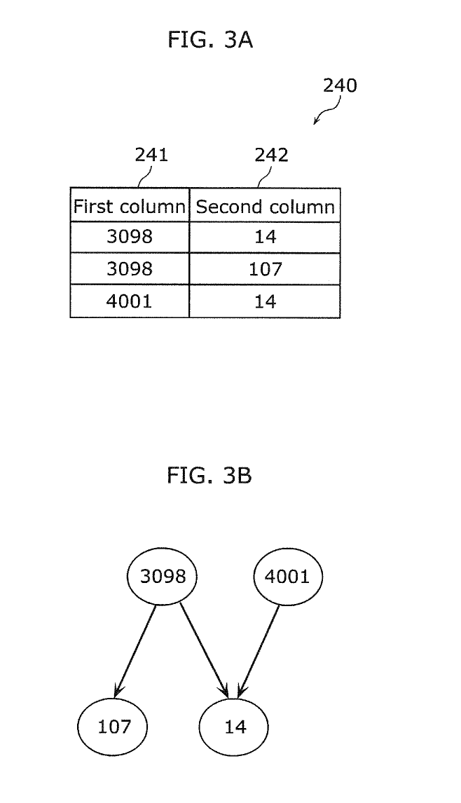

FIG. 3A shows a data table 240 recorded on the table lookup apparatus 200 according to Embodiment 1 of the present invention.

As shown in FIG. 3A, the data table has a first column 241 and a second column 242 associated with the first column 241. The data table may further include columns other than them. The data table shown in FIG. 3A includes three rows in addition to the header row, which is the first row, but the data table may include more rows.

Assume that the data shown in FIG. 3A indicates junctions between neurons. FIG. 3B shows junctions between neurons shown in FIG. 3A using a digraph. The values in the first column 241 indicate node numbers of neurons to be parent nodes (for example, 3098 and 4001), and the values in the second column 242 indicate node numbers of neurons to be child nodes (for example, 14 and 107). The data recoded in the table lookup system 100 according to Embodiment 1 is not limited to the illustration and may be any data table including a first column and a second column associated with the first column.

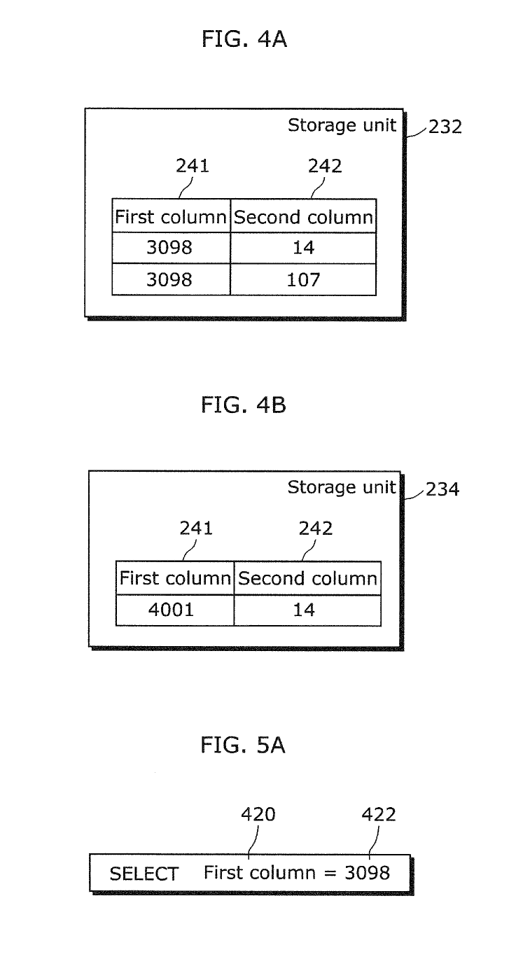

FIG. 4A shows a first split table stored in the storage unit 232 included in the table lookup apparatus according to Embodiment 1 of the present invention. FIG. 4B shows a second split table stored in the storage unit 234 included in the table lookup apparatus according to Embodiment 1 of the present invention.

As shown in FIG. 4A and FIG. 4B, the split tables each have a first column 241 and a second column 242.

The split unit 302 splits the data table into rows (and couples them) to generate a plurality of split tables under the following conditions.

First, the split unit 302 selects one of the first column 241 and the second column 242 as a “reference column”. Assume for illustrative purposes that the first column 241 is selected as a reference column.

Next, the split unit 302 splits the data table 240 into rows so that (A) in each of the resulting split tables, all values included in the first column 241, which is the reference column, are the same and (B) the value included in the first column 241, which is the reference column of each of the split tables, is unique to the split table.

More specifically, for example, the split unit 302 (1) sorts the rows in the data table 240 in descending or ascending order based on the values included in the first column 241 and (2) splits the data table 240 into rows so that each split table includes all the rows which include a common value in the first column 241.

As a result, the data table 240 is split into the first split table shown in FIG. 4A and the second split table shown in FIG. 4B. The first column 241 of the first split table includes no value other than the value of 3098, and the first column 241 of the second split table includes no value other than the value of 4001. Moreover, the first split table is the only split table that includes the value of 3098 in the first column 241, and the second split table is the only split table that includes the value of 4001 in the first column 241.

Optionally, the second column can be used as a reference column for generation of split tables. Other feasible methods of generation of split tables will be described in detail later.

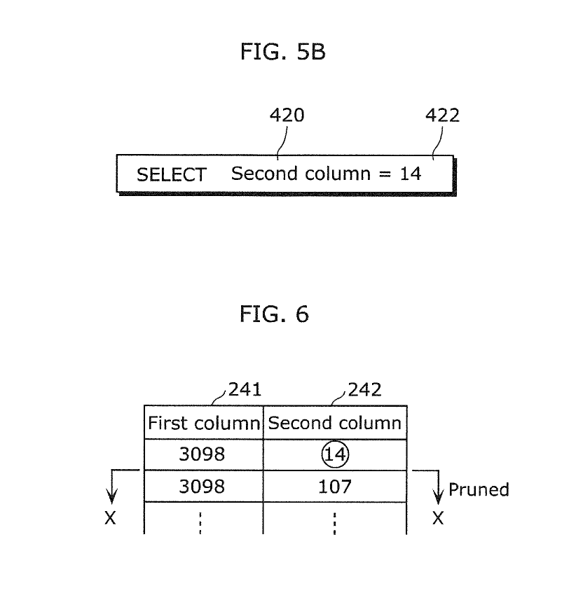

FIG. 5A shows a first search query to be handled by the lookup unit 233 included in the table lookup system 100 according to Embodiment 1 of the present invention. FIG. 5B shows a second search query to be handled by the lookup unit 233 included in the table lookup system 100 according to Embodiment 1 of the present invention.

The search queries each has a column identifier 420 and a search value 422 which follow the string of “SELECT”. The column identifier 420 specifies which of the first column 241 and the second column 242 of each of the split tables is to be looked up. The search value 422 is a value to be searched for by looking up the column specified by the column identifier 420.

Hereinafter, a process performed when the receiving and processing unit 220 and the receiving and processing unit 221 receive the first search query shown in FIG. 5A from the transmission unit 210 will be concretely described.

In the first search query, the column identifier 420 specifies the first column 241 and the search value 422 specifies 3098.

The lookup unit 233 included in the receiving and processing unit 220 thus looks up the first column 241 of the first split table stored in the storage unit 232 to determine whether or not the value of 3098 is included in the first column 241.

As is obvious from the method of generating the split tables, it is ensured that all values included in the first column 241, which is the reference column, are the same. It is therefore possible for the lookup unit 233 included in the receiving and processing unit 220 to determine whether or not that the first column 241 of the first split table includes the value of 3098 only by comparing the value in the first row below the header row with the search value of 3098.

In this case, in the first split table, the value included in the first column 241 of the first row below the header row matches the value of 3098, and therefore the lookup unit 233 included in the receiving and processing unit 220 outputs all the values included in the second column 242 associated with the first column 241. Specifically, the lookup unit 233 included in the receiving and processing unit 220 outputs values of 14 and 107 to the control unit 230 as output retrieval values.

One of other possible methods by which the lookup unit 233 can determine which of the first column 241 and the second column 242 is the reference column is that the split unit 302 includes in each of the split tables information indicating which of the first column 241 and the second column 242 is the reference column. Another one of the possible methods is that the split unit 302 sends, to the control unit 230, information indicating which of the first column 241 and the second column 242 is the reference column in addition to the split tables, and the control unit 230 sends the information to all the receiving and processing units via the transmission unit 210.

Next, in the same manner, the lookup unit 233 included in the receiving and processing unit 221 determines whether or not the value in the first column 241 and in the first row below the header row of the second split table stored in the storage unit 234 matches the value of 3098. In this case, the value in the first column 241 and in the first row of the second split table is 4001, and therefore the lookup unit 233 included in the receiving and processing unit 221 outputs nothing.

The lookup units 233 included in the receiving and processing unit 220 and the receiving and processing unit 221 perform the above-described process so that the control unit 230 included in the table lookup apparatus 200 can output, to the query apparatus 300, all the values (14 and 107) included in the second column associated with the first column which is the reference column of the data table 240 and includes the value of 3098.

Next, a process performed when the receiving and processing unit 220 and the receiving and processing unit 221 receive the second search query shown in FIG. 5B from the transmission unit 210 will be concretely described.

In the second search query, the column identifier 420 specifies the second column 242 and the search value 422 specifies 14.

The lookup unit 233 included in the receiving and processing unit 220 thus looks up the first column 241 of the first split table stored in the storage unit 232 to determine whether or not the value of 14 is included in the second column 242, and outputs all the values included in the first column 241 associated with the second column 242 when the lookup unit 233 determines that the value of 14 is included in the second column 242.

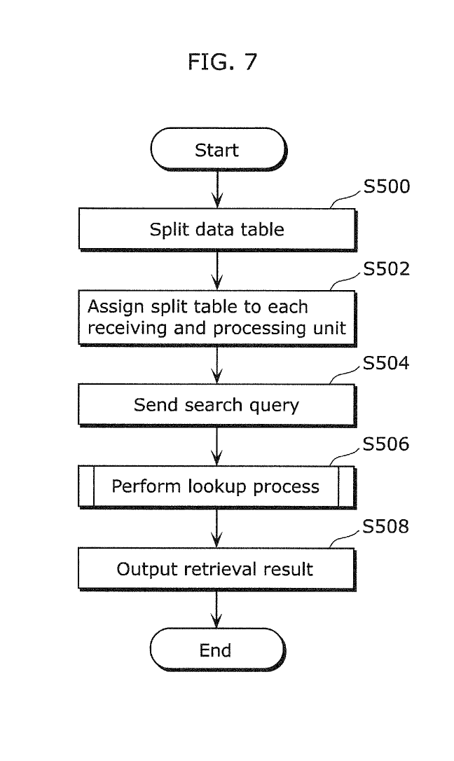

The lookup process is detailed below with reference to FIG. 6.

FIG. 6 shows a process performed on the second search query shown in FIG. 5B by the table lookup apparatus according to Embodiment 1 of the present invention.

As is obvious from the method of generating the split tables in Embodiment 1, all the values included in the first column 241 of the first split table are the value of 3098. It is therefore possible for the lookup unit 233 included in the receiving and processing unit 220 to discontinue the lookup of the second column 242 when the lookup unit 233 first determines that the search value of 14 is included in the second column 242, and to outputs all the values (3098) included in the first column 241. In other words, this process allows pruning of the search space of the second column 242 associated with the first column 241 by making use of the situation that all the values included in the first column 241 are the same.

In this case, the lookup unit 233 included in the receiving and processing unit 220 discontinues the lookup when the lookup unit 233 determines that the value of 14 is included in the second column 242 of the first split table, and then outputs the value of 3098, which is all the values included in the first row below the header row of the first column 241 associated with the second column 242, as an output retrieval value.

In the same manner, the lookup unit 233 included in the receiving and processing unit 221 looks up the second column 242 of the second split table stored in the storage unit 234 to determine whether or not the value of 14 is included in the second column 242. In this case, the value in the first row of the second column 242 of the second split table matches the value of 14, and therefore the lookup unit 233 included in the receiving and processing unit 221 outputs the value of 4001, which is all the value included in the first column 241, as an output retrieval value.

The receiving and processing unit 220 and the receiving and processing unit 221 included in the lookup units 233 perform the above-described process so that the control unit 230 included in the table lookup apparatus 200 can output, to the query apparatus 300, all the values (3098 and 4001) included in the first column 241 associated with the second column 242 which includes the value of 14 in the data table 240.

The search queries shown in FIG. 5A and FIG. 5B are provided only for illustrative purposes, and the search query may be in a different format. The search query needs to include at least a column identifier and a search value.

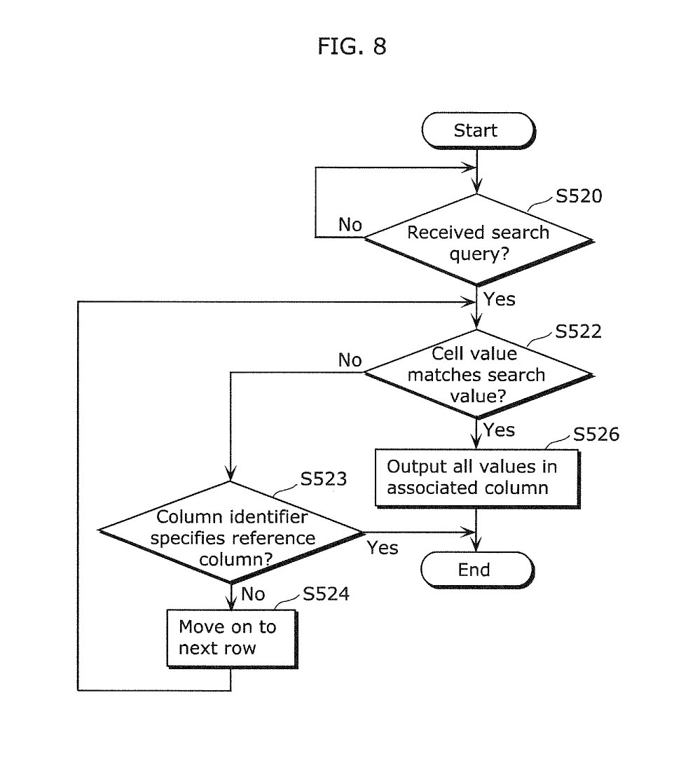

The above description regarding the process performed by the units in the table lookup system 100 will be organized with reference to FIG. 7.

FIG. 7 is a flowchart showing the steps of the process performed in the table lookup system 100 according to Embodiment 1 of the present invention.

First, the split unit 302 splits a data table to be looked up into split tables (S500).

Next, the split unit 302 assigns each of the split tables to a corresponding one of the receiving and processing units included in the table lookup apparatus 200 (S502).

Next, the query unit 303 sends a search query to the control unit 230. The search query includes at least a column identifier 420 and a search value 422.

Next, the control unit 230 sends the received search query to the transmission unit 210. Then, the transmission unit 210 necessarily sends the received search query to all the receiving and processing units included in the table lookup apparatus 200 (S504).

Next, upon receiving the search query, the respective receiving and processing units perform a lookup process using the lookup unit 233 (S506), and outputs a retrieval result of the lookup process to the control unit 230.

Finally, the control unit 230 organizes the retrieval results received from the receiving and processing units as necessary, and outputs a final retrieval result to the query apparatus 300 (S508).

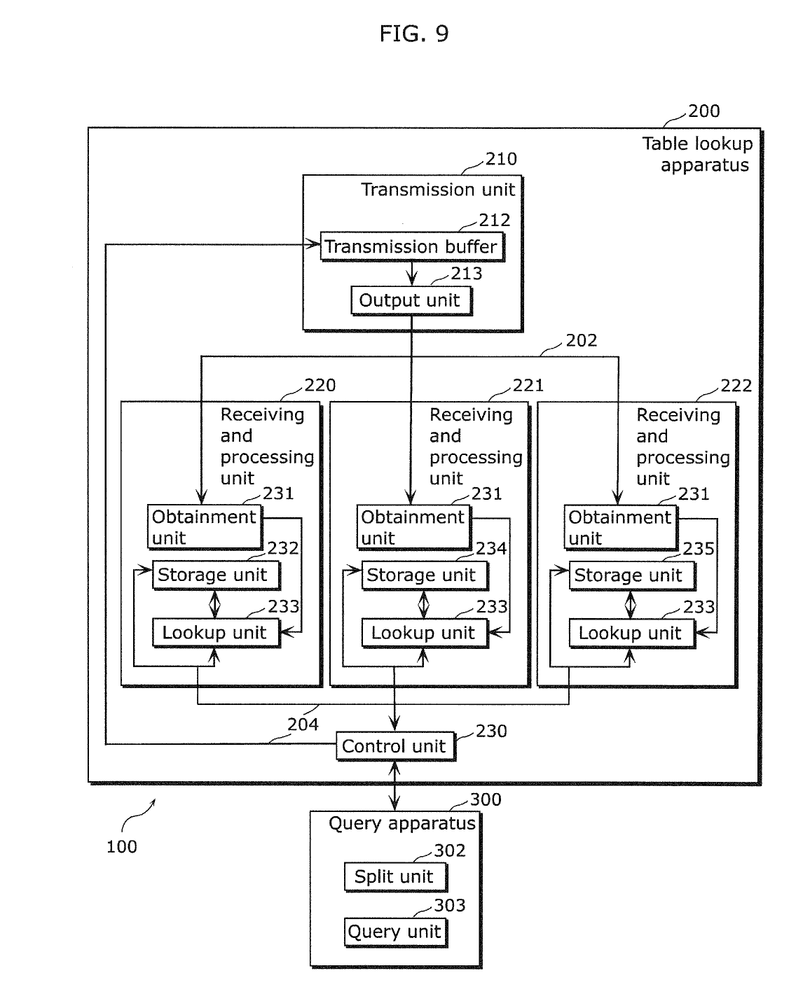

FIG. 8 is a flowchart showing the steps of the lookup process performed by each of the lookup units 233 included in the receiving and processing units according to Embodiment 1 of the present invention.

First, the lookup unit 233 determines whether or not the lookup unit 233 has received a search query (S520). When the lookup unit 233 has not received a search query (No in S520) from the transmission unit 210, the lookup unit 233 waits for a search query again.

When the lookup unit 233 has received a search query (Yes in S520), the lookup unit 233 acquires a column identifier and a search value included in the search query. Next, the lookup unit 233 determines whether or not the value in a row to be looked up of a column (the first column 241 or the second column 242) which the column identifier specifies out of the columns stored in the storage unit matches the search value (S522). Here, for example, the first row below the header row of the split table stored in the storage unit is specified as the row to be looked up. The storage unit storing the object of lookup by the lookup unit 233 according to Embodiment 1 is limited to the one included in the receiving and processing unit which includes the lookup unit 233 itself.

When the value in the first row does not match the search value (No in S522), the lookup unit 233 determines whether or not the column specified by the column identifier is the reference column (S523). When the column specified by the column identifier is the reference column (Yes in S523), the lookup unit 233 terminates the lookup process because further lookup is ineffective. When the column specified by the column identifier is not the reference column (No in S523), the lookup unit 233 selects the next row as a row to be looked up (S524) and determines whether or not the value in the row to be looked up of the same column matches the search value (S522).

When the value in the first row matches the search value (Yes in S522), the lookup unit 233 outputs, as output retrieval values, all the values in the column associated with the column specified by the column identifier (S526). For example, the lookup unit 233 outputs all the values included in the second column 242 when the column identifier specifies the first column 241.

In the above-described table lookup apparatus 200 according to Embodiment 1, each of the receiving and processing unit stores one of split tables prepared by splitting a data table to be looked up. The data table includes a first column and a second column. In addition, the split tables are prepared so that the value in the reference column, which is either the first column or the second column, is unique to each of the resulting split tables.

This allows the table lookup apparatus 200 to output a retrieval result in response to the following queries (1) and (2) as fast as in the case where an index is prepared, even without preparing an index.
(1) For each row in the data table, output the value in the second column if the value in the first column matches the search value.
(2) For each row in the data table, output the value in the first column if the value in the second column matches the search value.

In summary, the table lookup apparatus 200 according to Embodiment 1 includes: (1) a plurality of receiving and processing units each configured to store a corresponding one of split tables generated by splitting a data table having a table structure of rows and columns into the rows, the columns including a first column and a second column associated with the first column; (2) a transmission unit 210; and (3) a control unit 230 configured to send, to the transmission unit 210, a search query including a column identifier and a search value, receive an output retrieval value, and output the received output retrieval value, the column identifier specifying one of the first column and the second column, and the output retrieval value being an output value from each of the receiving and processing units.

The transmission unit 210 sends the search query received from the control unit 230 to all the receiving and processing units. Furthermore, each of the receiving and processing units is configured to determine whether or not the search value in the received search query is included in the column specified by the column identifier included in the search query, and output, as the output retrieval value, a value included in the column associated with the column specified by the column identifier, when the search value is included in the column specified by the column identifier.

Furthermore, the table lookup apparatus 200 according to Embodiment 1 may further include a split unit 302 configured to generate a plurality of split tables from the data table. In this case, the control unit 230 is configured to receive the split tables from the split unit 302 and store each of the received split tables in a corresponding one of the receiving and processing units.

The split unit 302 is configured to select, for the data table, one of the first column and the second column as a reference column, and generate the split tables so that in each of the split tables, all values included in the reference column are the same.

Furthermore, the split unit 302 may be configured to select one of the first column and the second column as a reference column for the data table, and generate the split tables so that (A) in each of the split tables, all values included in the reference column are the same and (B) the value included in the reference column of each of the split tables is unique to the split table.

Furthermore, the control unit 230 is configured to send, to the transmission unit 210, the search query in which (i) an identifier specifying the reference column is included as the column identifier and (ii) a value for which the reference column is looked up is included as the search value.

Furthermore, the control unit 230 is configured to send, to the transmission unit 210, the search query in which (i) an identifier specifying a third column is included as the column identifier and (ii) a value for which the third column is looked up is included as the search value, the third column being the other of the first column and the second column and being associated with the reference column which is the one of the first column and the second column.

### Embodiment 2

A table lookup system 100 and a table lookup apparatus 200 according to Embodiment 2 shall be described below. Embodiment 2 is different from Embodiment 1 in a method of generating split tables to be stored in the receiving and processing units.

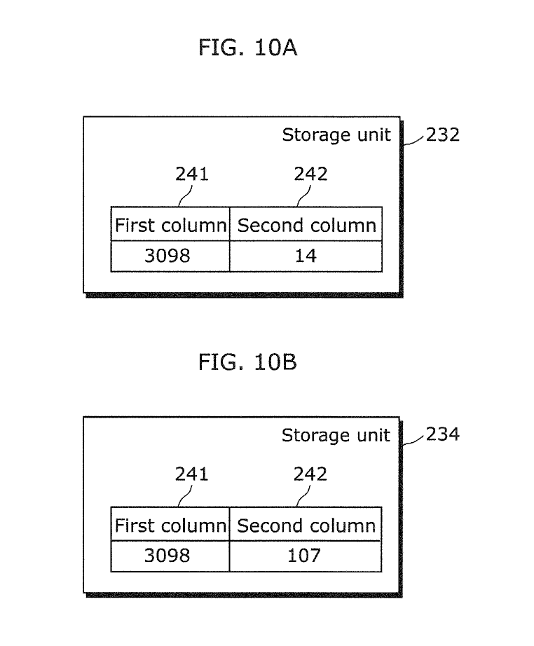

FIG. 9 is a block diagram showing an overall configuration of the table lookup system 100 including the table lookup apparatus 200 according to Embodiment 2 of the present invention.

The configurations of the table lookup apparatus 200 according to Embodiment 2 and the table lookup apparatus 200 according to Embodiment 1 are all the same but different in three receiving and processing units (a receiving and processing unit 220 to a receiving and processing unit 222).

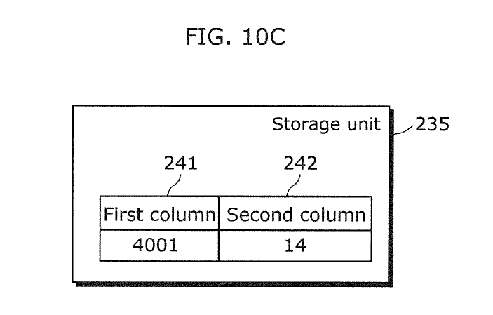

In Embodiment 2, each of the rows included in the data table 240 is stored in a corresponding one of the receiving and processing units in association. This is detailed below using FIG. 10.

FIG. 10A shows a first split table stored in the table lookup apparatus 200 according to Embodiment 2 of the present invention. FIG. 10B shows a second split table stored in the table lookup apparatus 200 according to Embodiment 2 of the present invention. FIG. 10C shows a third split table stored in the table lookup apparatus 200 according to Embodiment 2 of the present invention.

The first split table to the third split table correspond to the rows of the data table 240, respectively. Specifically, the split unit 302 generates the split tables each corresponding to a different row by splitting the data table 240 into single rows. Specifically, the first row of the data table 240 corresponds to the first split table, the second row of the data table 240 to the second split table, and the third row of the data table 240 to the third split table.

Hereinafter, Embodiment 2 will be described on the assumption that the split unit 302 has selected the first column 241 as a reference column as is the case in Embodiment 1.

First, the split unit 302 stores each of the generated split tables in a different one of the receiving and processing units. In Embodiment 2, the split unit 302 stores the first split table in a storage unit 232 included in the receiving and processing unit 220, the second split table in a storage unit 234 included in the receiving and processing unit 221, and the third split table in a storage unit 235 included in the receiving and processing unit 222. The split unit 302 designates the receiving and processing units to store the respective split tables using the same method as in Embodiment 1.

A transmission unit 210 sends a received search query to each of the receiving and processing units storing a split table having only one row in addition to a header row in its storage unit.

A process performed by a receiving and processing unit upon receiving a search query shall be described below using the receiving and processing unit 220 as an example. The process is performed also by the other receiving and processing units.

The lookup unit 233 included in the receiving and processing unit 220 acquires a column identifier 420 and a search value 422 from the search query. Next, the lookup unit 233 determines, for the first split table stored in the storage unit 232, whether or not the value in the column specified by the column identifier 420 matches the search value 422. Since the first split table includes only one row, the determination is always made by one comparison.

For example, referring to FIG. 5A, when the receiving and processing unit 220 receives a first search query, the lookup unit 233 determines whether or not the value in the first column 241 specified by the column identifier 420 matches the value of 3098. The result of the determination shows that the value in the first column 241 matches the value of 3098, and therefore the lookup unit 233 outputs all the value (the value of 14) included in the second column 242, which is the other column, to the control unit 230.

The control unit 230 thus receives values output from the lookup unit 233 included in all the receiving and processing units so that the table lookup apparatus 200 can perform a lookup on the data table 240 according to the first search query.

When the receiving and processing unit 220 receives a second search query, the process performed by the lookup unit 233 is all the same as in the case where the first search query is received but different only in determining whether or not the value included in the second column 242 specified by the column identifier 420 matches the value of 14.

Specifically, the split unit 302 included in the table lookup apparatus 200 according to Embodiment 2 generates the split tables by splitting the data table into single rows.

In the above-described table lookup system 100 according to Embodiment 2, each of the rows of the data table 240 is associated with a different one of the receiving and processing units and stored in a storage unit included in the receiving and processing unit. As a result, each of the receiving and processing units can output a retrieval result only after making a single comparison for a received search query. The control unit 230 collects outputs from the receiving and processing units so that the table lookup apparatus 200 can look up a data table fast compared to Embodiment 1, even without preparing an index.

### Embodiment 3

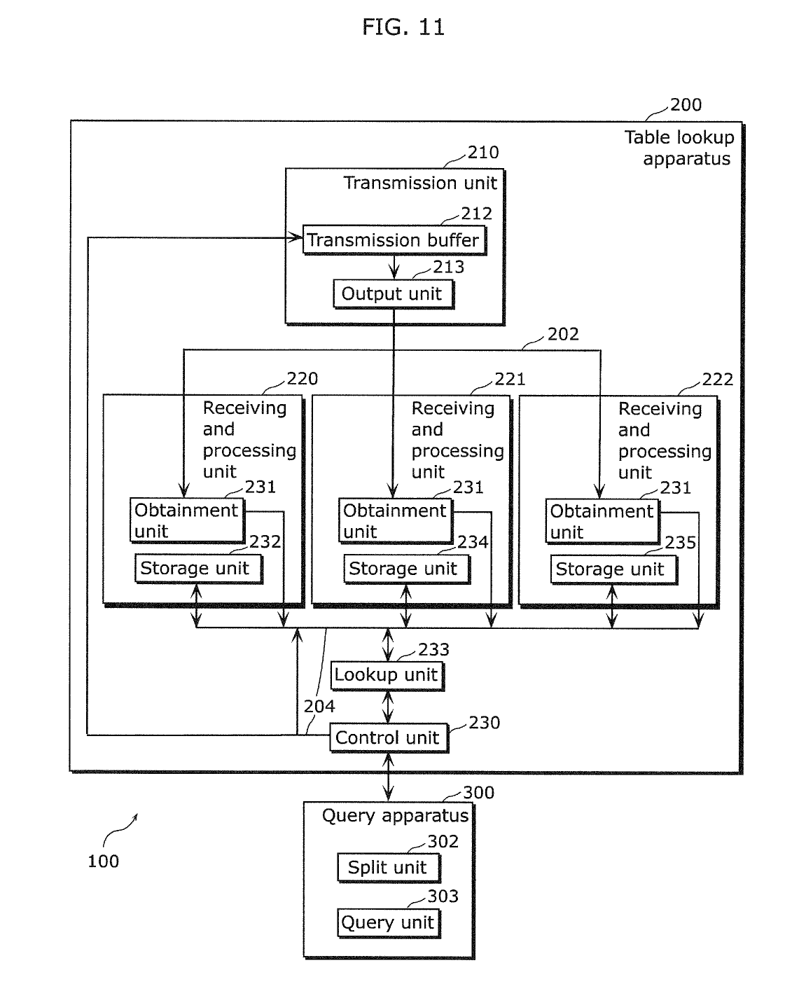

FIG. 11 is a block diagram showing an overall configuration of a table lookup system 100 including a table lookup apparatus 200 according to Embodiment 3 of the present invention.

Embodiment 3 is different from Embodiment 2 in that a plurality of receiving and processing units (a receiving and processing unit 220 to a receiving and processing unit 222) shares a single lookup unit 233.

In Embodiment 2, a storage unit included in each of the receiving and processing unit stores only a split table corresponding to a row of a data table. The load of lookup process performed by the lookup unit 233 is therefore light. In this case, a lookup unit 233 is not necessary for all the receiving and processing units included in the table lookup apparatus 200, and a lookup unit 233 can be shared by a certain number of the receiving and processing units as shown in FIG. 11.

This makes the configuration of the receiving and processing unit 221 simpler so that costs, size, or power consumption of the table lookup apparatus 200 can be reduced.

### Embodiment 4

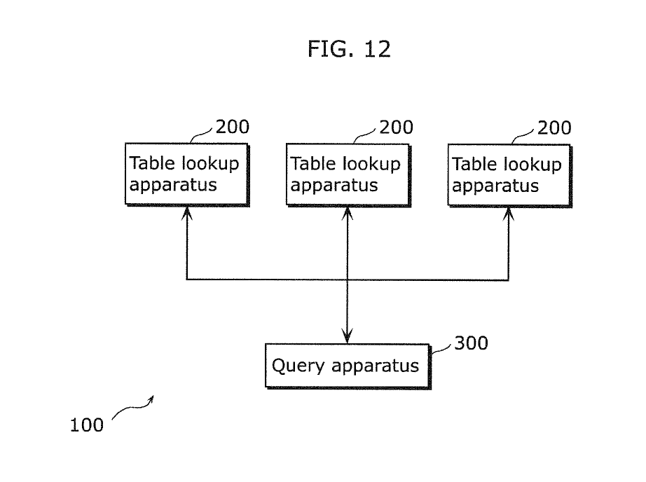

FIG. 12 is a block diagram showing an overall configuration of a table lookup system 100 including table lookup apparatuses 200 according to Embodiment 4 of the present invention.

In Embodiment 4, the table lookup system 100 includes a plurality of table lookup apparatuses 200.

Each of the table lookup apparatuses 200 can be configured according to any of Embodiments 1 to 3.

In lookup in the table lookup system 100 according to Embodiment 4, a query unit 303 included in a query apparatus 300 sends a search query to all the table lookup apparatuses 200 at the same time. Upon receiving the search query, each of the table lookup apparatus 200 sends the received search query to receiving and processing units of its own. Afterwards, each of the receiving and processing units performs a lookup process as describe in Embodiments 1 to 3.

This configuration is advantageous particularly when the table lookup apparatuses are implemented using hardware such as an integrated circuit, providing scalability to the table lookup system 100.

Specifically, even in the case where a data table 240 is so large that the number of split tables generated by splitting the data table 240 is larger than the number of receiving and processing units included in the table lookup apparatus 200, the number of receiving and processing units included in the table lookup system 100 can be increased by connecting as many table lookup apparatuses 200 as necessary in parallel to the query apparatus 300. This provides a table lookup system 100 which can look up a data table 240 of any size.

Optionally, in the table lookup system 100 in any of Embodiments 1 to 4, the split unit 302 may be included not in the query apparatus 300 but in the control unit 230 included in the table lookup apparatus 200.

Optionally, in the table lookup system 100 in any of Embodiments 1 to 4, the query apparatus 300 may store a plurality of data tables in the table lookup apparatus 200.

In this case, a specific lookup process is as follows:
(1) the query apparatus 300 assigns a unique table identifier to each of the data tables;
(2) the split unit 302 includes the table identifier assigned to the data tables in each of the split tables generated by splitting the data tables;
(3) the storage unit holds the split table including the table identifier;
(4) the query unit 303 generates a query including the table identifier specifying a data table to be looked up and sends the query to the control unit 230; and
(5) the lookup unit 233 determines matching between the table identifiers and matching between search values.

The table lookup apparatus 200 thereby stores a plurality of data tables when the data tables are small in size for the number of receiving and processing units included in the table lookup apparatus 200 so that the table lookup apparatus 200 can be used more efficiently.

Optionally, the lookup units 233 included in the table lookup system 100 according to any of Embodiments 1 to 4 may determine not whether or not the storage units store a specific value but whether or not the storage units store any value within a specified range. For example, the lookup units 233 may determine a value in a cell in the first column matches a search value (Step S522) when the value in the cell is a value within a range from 3040 to 3090.

It should be noted that the present invention is not limited to above-described Embodiments 1 to 4. For example, the present invention may be embodied as any combination of Embodiments 1 to 4.

Moreover, Embodiments in the present disclosure are provided only for illustrative purposes in all aspects and should not be considered as limiting the scope of the present invention. The scope of the present invention is defined not by the description above but by the claims, and is intended to include any modification within a sense and scope equivalent to the claims.

### INDUSTRIAL APPLICABILITY

The present invention is applicable to table lookup apparatuses, and particularly to a table lookup apparatus or the like which looks up a table stored in dispersion in a network.

### REFERENCE SIGNS LIST

32 Display
34 Computer
36 Keyboard
38 Mouse
40 CD-ROM device
42 CD-ROM
44 CPU
46 ROM
48 RAM
50 Hard disk
52 Communication modem
54 Bus
100 Table lookup system
200 Table lookup apparatus
202 First transmission channel
204 Second transmission channel
210 Transmission unit
212 Transmission buffer
213 Output unit
220, 221, 222 Receiving and processing unit
230 Control unit
231 Obtainment unit
232, 234, 235 Storage unit
233 Lookup unit
240 Data table
241 First column
242 Second column
300 Query apparatus
302 Split unit
303 Query unit
420 Column identifier
422 Search value

1. A table lookup apparatus comprising:
a plurality of receiving and processing units each configured to store a corresponding one of split tables generated by splitting a data table having a table structure of rows and columns into the rows, the columns including a first column and a second column associated with the first column;
a transmission unit; and
a control unit configured to send, to the transmission unit, a search query including a column identifier and a search value, receive an output retrieval value, and output the received output retrieval value, the column identifier specifying one of the first column and the second column, and the output retrieval value being an output value from each of the receiving and processing units,
wherein the transmission unit is configured to send the search query received from the control unit to all the receiving and processing units, and
each of the receiving and processing units is configured to determine whether or not the search value in the received search query is included in the column specified by the column identifier included in the search query, and output, as the output retrieval value, a value included in the column associated with the column specified by the column identifier, when the search value is included in the column specified by the column identifier.

2. The table lookup apparatus according to claim 1, further comprising
a split unit configured to generate the plurality of split tables from the data table,
wherein the control unit is configured to receive the split tables from the split unit, and store each of the received split tables in a corresponding one of the receiving and processing units.

3. The table lookup apparatus according to claim 2,
wherein the split unit is configured to select, for the data table, one of the first column and the second column as a reference column, and generate the split tables so that in each of the split tables, all values included in the reference column are the same.

4. The table lookup apparatus according to claim 2,
wherein the split unit is configured to select one of the first column and the second column as a reference column for the data table, and generate the split tables so that (A) in each of the split tables, all values included in the reference column are the same and (B) the value included in the reference column of each of the split tables is unique to the split table.

5. The table lookup apparatus according to claim 3,
wherein the control unit is configured to send, to the transmission unit, the search query in which (i) an identifier specifying the reference column is included as the column identifier and (ii) a value for which the reference column is looked up is included as the search value.

6. The table lookup apparatus according to claim 3,
wherein the control unit is configured to send, to the transmission unit, the search query in which (i) an identifier specifying a third column is included as the column identifier and (ii) a value for which the third column is looked up is included as the search value, the third column being the other of the first column and the second column and being associated with the reference column which is the one of the first column and the second column.

7. The table lookup apparatus according to claim 2,
wherein the split unit is configured to generate the plurality of split tables by splitting the data table into single rows.

8. The table lookup apparatus according to claim 7,
wherein two or more of the receiving and processing units share a lookup unit which is a processing unit configured to determine whether or not the search value is included in the column specified by the column identifier.

9. A table lookup system comprising:
a plurality of the table lookup apparatuses according to claim 1; and
a query apparatus connected to all the table lookup apparatuses,
wherein the query apparatus is configured to send the search query to all of the table lookup apparatuses.

10. A table lookup method performed by a table lookup apparatus including:
a plurality of storage units in each of which a corresponding one of split tables generated by splitting a data table having a table structure of rows and columns into the rows is stored, the columns including a first column and a second column associated with the first column; and a lookup unit configured to look up at least one of the storage units, the method comprising:
receiving a search query including a column identifier and a search value, the column identifier specifying one of the first column and the second column;
sending the search query to the lookup unit;
determining, using the lookup unit, whether or not the search value in the received search query is included in one of the columns of the corresponding one of the split tables, the one of the columns being specified by the column identifier included in the search query; and
outputting a value from the lookup unit as the output retrieval value when the lookup unit determines that the search value is included in the one of the columns, the value being included in the column associated with the column specified by the column identifier.

11. A non-transitory computer-readable recording medium on which a program which causes a computer to execute the table lookup method according to claim 10 is recorded.

12. (canceled)

13. An integrated circuit comprising:
a plurality of receiving and processing units each configured to store a corresponding one of split tables generated by splitting a data table having a table structure of rows and columns into the rows, the columns including a first column and a second column associated with the first column;
a transmission unit; and
a control unit configured to send, to the transmission unit, a search query including a column identifier and a search value, receive an output retrieval value, and output the received output retrieval value, the column identifier specifying one of the first column and the second column, and the output retrieval value being an output value from each of the receiving and processing units,
wherein the transmission unit is configured to send the search query received from the control unit to all receiving and processing units which are among the receiving and processing units and store the split tables, and
each of the receiving and processing units is configured to determine whether or not the search value in the received search query is included in the column specified by the column identifier included in the search query, and output, as the output retrieval value, a value included in the column associated with the column specified by the column identifier, when the search value is included in the column specified by the column identifier.

14. The table lookup apparatus according to claim 4,
wherein the control unit is configured to send, to the transmission unit, the search query in which (i) an identifier specifying the reference column is included as the column identifier and (ii) a value for which the reference column is looked up is included as the search value.

15. The table lookup apparatus according to claim 4,
wherein the control unit is configured to send, to the transmission unit, the search query in which (i) an identifier specifying a third column is included as the column identifier and (ii) a value for which the third column is looked up is included as the search value, the third column being the other of the first column and the second column and being associated with the reference column which is the one of the first column and the second column.
